(19) United States
(12) Patent Application Publication
(10) Pub. No.: US 2003/0123540 A1
(43) Pub. Date: Jul. 3, 2003

(54) Dynamic control in complexity-constrained data compression

(75) Inventors: Zhun Zhong, Croton On Hudson, NY (US); Yingwei Chen, Briarcliff Manor, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/029,829

(22) Filed: Dec. 27, 2001

(51) Int. Cl. H04N 7/12

(52) U.S. Cl. 375/240.07; 375/240.05

(57) ABSTRACT

A method and system of regulating the computation load of an MPEG encoder in a video processing system are provided. A stream of data blocks is received and buffered temporarily for subsequent retrieval during an encoding mode. The buffered data block is then retrieved from the buffer for an encoding operation in accordance with a conventional encoding method. Meanwhile, the fullness level of the buffer is monitored to determine an appropriate encoding complexity for a subsequent encoding process. To this end, a predetermine threshold range is compared to the fullness level so that the subsequent encoding operation can be performed at an improved buffer efficiency.

### BACKGROUND OF THE INVENTION

1. Field of the Invention

The present invention relates to video processing of incoming video information and, more particularly, to a method and device for dynamically controlling the computation load of an MPEG encoder in real time.

2. Description of the Related Art

Video information is typically compressed to save storage space and decompressed in a bit stream for display. Thus, it is highly desirable to encode video information quickly and efficiently in order to deliver a relatively consistent video quality with a minimum number of bits over a variable bit rate (VBR) or constant bit rate (CBR) channel. One compression standard which has attained widespread use for compressing and decompressing video information is the Moving Pictures Expert Group (MPEG) standard for video encoding and decoding. The MPEG standard is defined in International Standard ISO/IEC 11172-1, “Information Technology—Coding of moving pictures and associated audio for digital storage media at up to about 1.5 Mbit/s”, Parts 1, 2, and 3, First edition 1993-08-01 which is hereby incorporated by reference in its entirety.

For engineers, the goal of many video systems is to encode video information quickly and efficiently when designing a video compression-based system in certain applications such as content authoring or real-time hardware video encoding. In the content-authoring case, the compression is performed off-line and therefore it doesn't matter (to some extent) how long it takes the encoder to finish encoding. Due to the irregular computation load behavior of MPEG2 encoding, the peak computation load of a frame may exceed the maximum load of a processor, thereby causing frame drops or unexpected results. In the real-time hardware encoder case, the hardware components must be over-engineered for the worst-case scenario allowed by the respective video-compression standard. This type of implementation is uneconomical and creates a waste of resources, as the undesirable peak computation load does not occur that frequently. Similarly, when an engineer implements MPEG2 encoding on a processor, he or she needs to choose a processor that has a performance margin of 40%-50% above the average decoding computation load in order to have a smooth operation in the event that the peak computation load occurs. This luxury of over-engineering is no longer readily available in general-purpose software encoders where computation resources are shared with other functions.

### SUMMARY OF THE INVENTION

The present invention relates to a method and system for ensuring real-time encoding while maximizing the encoding efficiency of an MPEG digital video encoder system by dynamically adjusting the computation load to obtain an optimal performance.

According to one aspect of the invention, a method of encoding a stream of data blocks using a scalable encoder includes the steps of: receiving a stream of data blocks; storing the received data blocks in a buffer; encoding a first sequence of the stored data blocks from the buffer to produce a first encoded data block; monitoring the fullness level of the buffer for comparison with a predetermined threshold range; and, adjusting the complexity of the encoder based on the comparison outcome. The step of adjusting the complexity of the encoder based on the comparison outcome comprises the steps of: decreasing the complexity of the encoder when the fullness level of the buffer exceeds an upper range of the threshold limit; encoding a second data block at the decreased complexity to produce a second encoded data block; maintaining the complexity of the encoder when the fullness level of the buffer falls within the predetermined threshold range; increasing the complexity of the encoder when the fullness level of the buffer is below a lower level of the predetermined threshold range; encoding a second data block at the increased complexity to produce a second encoded data block, wherein the step of increasing and decreasing the complexity of the encoder is performed according to a predetermined encoding configuration table. The method further includes the step of storing the first encoded data blocks in a memory medium for subsequent retrieval. In this invention, the stream of data blocks comprises a stream of video frames.

According to another aspect of the invention, a method of encoding a stream of data blocks using a scalable encoder includes the steps of: temporarily storing the stream of the data blocks in a buffer; retrieving a first sequence of the stored data blocks from the buffer; encoding the first sequence of the stored data blocks from the buffer to produce a first encoded data block; monitoring the fullness level of the buffer; comparing the fullness level of the buffer to a predetermined threshold range; increasing the complexity of the encoder when the fullness level of the buffer is below a lower level of the predetermined threshold range; and, decreasing the complexity of the encoder when the fullness level of the buffer is below an upper level of the predetermined threshold range, wherein the steps of increasing and decreasing the complexity of the encoder is performed according to a predetermined encoding configuration table. The method further includes the steps of encoding a second data block at the increased complexity to produce a second encoded data block, and encoding a second data block at the decreased complexity to produce a second encoded data block. The fullness level of the buffer is determined based on an input rate of the stream of the data blocks and processing feedback information from the encoder after producing the first encoded data block.

According to a further aspect of the invention, an encoding system for encoding a stream of data blocks includes: an analog-to-digital converter for converting analog signals from a plurality of sources into digital signals; a buffer for receiving the converted digital signals at a predefined rate; a memory for storing a predetermined encoding configuration table; an encoder for encoding the stream of data blocks stored in the buffer; a management module, operatively coupled to the buffer, the encoder, and the memory, wherein the management module is operable to: (a) receive the stream of the data blocks; (b) store the received data blocks in the buffer; (c) cause to encode a first sequence of the stored data blocks from the buffer to produce a first encoded data block; (d) monitor the fullness level of the buffer for comparison with a predetermined threshold range; (e) cause to adjust the complexity of the encoder based on the comparison outcome and the predetermined encoding table; and, (f) cause to encode a second data block at the adjusted complexity to produce a second encoded data block. The management module is further operable to decrease the complexity of the encoder when the fullness level of the buffer exceeds an upper range of the threshold limit; increase the complexity of the encoder when the fullness level of the buffer is below a lower level of the predetermined threshold range; and, maintain the complexity of the encoder when the fullness level of the buffer falls within the predetermined threshold range.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 shows one embodiment of the processor for regulating the computation load in compressing video information.

FIG. 2 shows an exemplary look up table that is used for adjusting the computation load of an encoder;

FIG. 3 shows a graphical representation of monitoring the fullness level of a buffer in accordance with the present invention; and,

FIG. 4 is a flow chart illustrating the process of adjusting the computation load of an encoder in accordance with the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For the purpose of simplicity and clarity, detailed descriptions of well-known devices, circuits, and methods are omitted so as not to obscure the description of the present invention with unnecessary detail.

In order to facilitate an understanding of this invention, a conventional method of compressing video data in accordance with the MPEG standard will be described briefly hereinafter.

There are three types of frames of video information which are defined by the MPEG standard, intra-frames (I frame), forward-predicted frames (P frame) and bi-directional-predicted frames (B frame). The I frame, or an actual video reference frame, is periodically coded, i.e., one reference frame for each fifteen frames. A prediction is made of the composition of a video frame, the P frame, to be located a specific number of frames forward and before the next reference frame. The B frame is predicted between the I frame and predicted P frames, or by interpolating (averaging) a macro block in the past reference frame with a macro block in the future reference frame. The motion vector is also encoded which specifies the relative position of a macro block within a reference frame with respect to the macro block within the current frame. The current frame may be encoded based on a previous frame and a subsequent frame. As such, one frame needs to be encoded based on the MPEG encoding convention, and then other frames relating to that frame are encoded based on the differences from that frame.

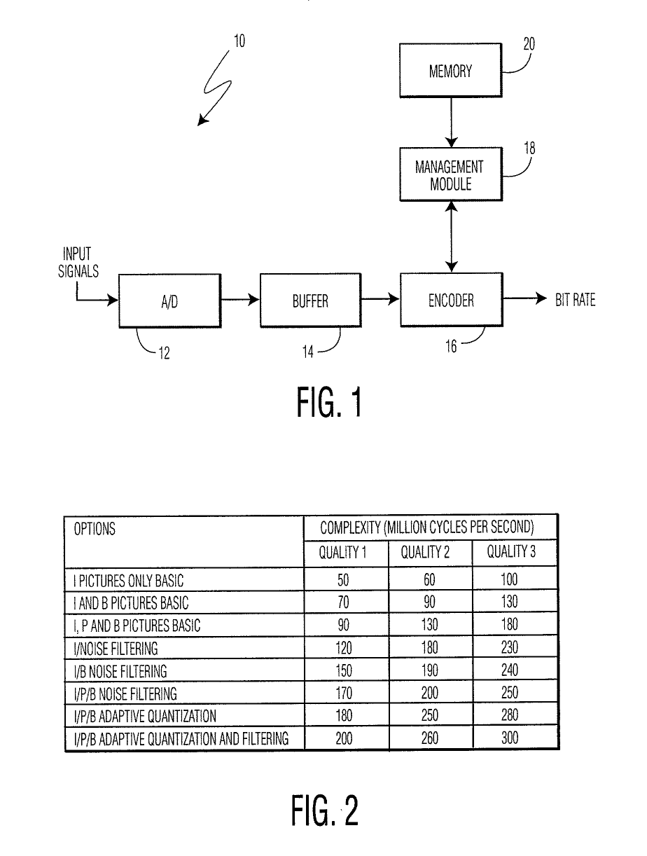

FIG. 1 illustrates a schematic block diagram of an encoding circuit 10 that is capable of encoding video signals according to an exemplary embodiment of the present invention. As shown in FIG. 1, the encoding circuit 10 according to the present invention for scaling the decoding process includes: an analog to digital (AID) converter 12; a buffer 14; an encoder 16; a management module 18; and, a memory 20. The input signals received by the A/D converter 12 may be signals from a camcorder, a DVD player, a VCR, a television tuner and/or any other device that receives digital information. The buffer 14 may be a conventional first-in, first-out (FIFO) buffer. The management module 18 may be the central processing unit of a personal computer, workstation, personal digital assistant (PDA), hand-held computer, and/or an integrated circuit such as a microprocessor, digital signal processor, micro-controller, micro-computer and/or any other device that manipulates digital information based on programming instructions. It should be noted that the encoder 16 can be incorporated into the management module 18. The memory 20 may be a hard drive memory, random access memory, read-only memory, external memory and/or any other device that stores digital information.

In operation, a stream of video information is converted from analog signals to digital signals by the A/D converter 12. The converted digital signals are then provided to the buffer 14. The function of the buffer 14 at the input of the encoder 16 is to smooth out short-term complexity fluctuation. Thereafter, the encoder 16, under the control of the management module 18, encodes the data stored in the buffer 14 such that the data is represented by a smaller amount of compressed data for storage in a local memory medium. By compressing data, processing entities may effectively process more data in a given time. The encoding performed by the encoder 16 in accordance with the MPEG standard is well known to those skilled in the art as described earlier. During an encoding mode, the management module 18 monitors the fullness of the buffer 14 such that the buffer utilization can be maximized without overflowing by adjusting the complexity of the encoder 16.

In this invention, the complexity constraint refers to the average complexity over the buffer. For example, if the buffer 14 contains 2 frame-input buffers and if the complexity constraint is 10 million instructions per frame and the first frame takes 15 million instructions, the encoding circuit 10 is still kept under the complexity constraint as long as the second frame takes less than 5 million instructions. In order not to overshoot over the complexity constraint, the management module 18 provides, based on the fullness level of the buffer 14, a dynamic control to switch the encoder 16 from one configuration point to another to ensure the complexity stay within the constraint. That is, once the monitoring process shows a complexity peak to a certain threshold limit, the encoder 16 switches to a configuration point with lower complexity. To this end, a predetermined look up table, as shown in FIG. 2, is stored in the memory 20. Thus, based on the fullness level of the buffer 14, the management module 18 either increases or decreases the complexity of the encoder 16.

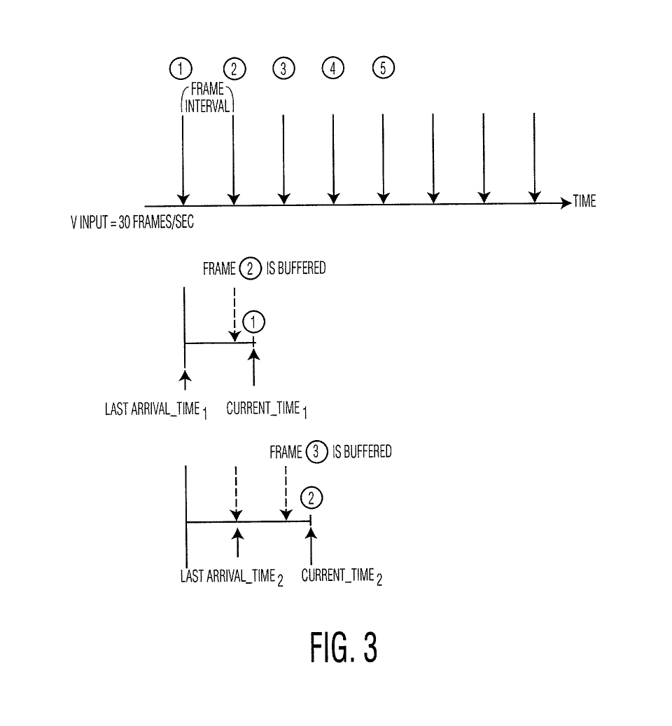

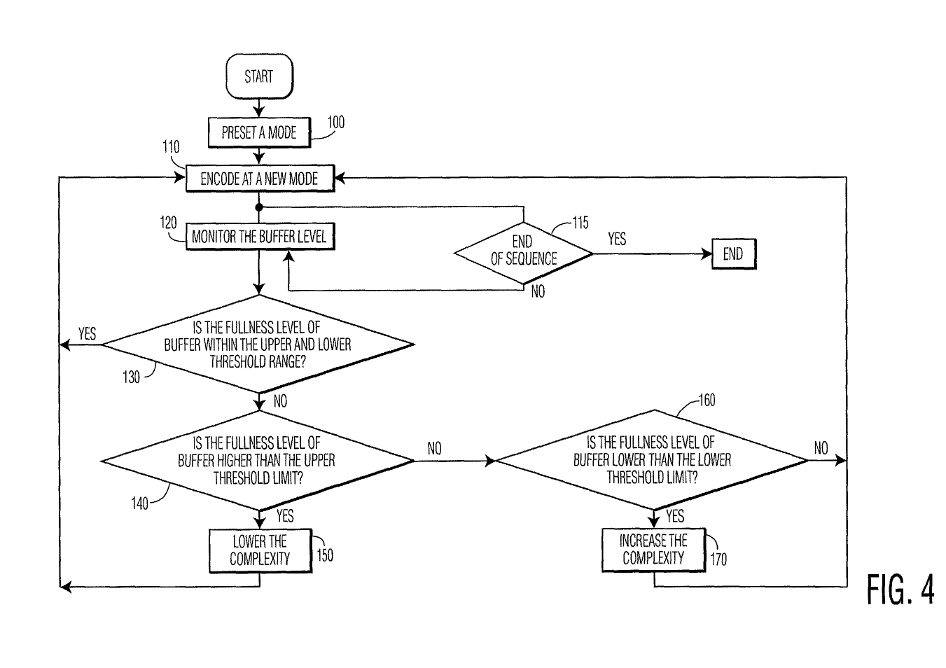

Referring to FIG. 3, the fullness level of the buffer 14 can be determined by the management module 18 based on the input rate of the video streams and the feedback information received from the encoder 16. As shown in FIG. 3, a stream of data frames at a predefined interval, for example, at a rate of 30 frames per second, is received in the buffer 14. The condition of the buffer during an encoding mode can be obtained according to the following equation:

current_time=frame start_time+frame process_time, and

new_arrival=(current_time−last arrival_time)/frame interval,

wherein “current_time” indicates the feedback information received from the encoder 16 after performing the encoding process on the frames, and “new_arrival” indicates the number of frames arrive in the buffer 14 during the encoding process. For example, at current_time₁, the first set of frames (denoted by 1) is encoded by the encoder 16 and then notified to the management module 18. Meanwhile, the second set of frames (denoted by 2) is temporally buffered in the buffer 14. At this time, the number of frames stored in the buffer 14 can be obtained as new_arrival₁=(current_time₁−last arrival_time₁)/frame interval. Thereafter, the last arrival_time₁ is updated (last arrival_time₂=last arrival_time₂+new_arrival₁*frame interval) for determining the behavior of the buffer for the next feedback information from the encoder 16. Since there is a frame waiting in the buffer, the encoder starts encoding the frame from the buffer right after finishing the first frame. Hence, frame_start_time2=current_time1. Note that if no frames are available in the buffer by the time the encoder finishes the first frame, the encoder can not encode the next frame right away. Instead, it has to remain idle until the arrival of next frame. In this case, frame start time2=last arrival time+frame interval time. At current time₂ (=frame_start_time2+frame_process_time2), the second set of frames (denoted by 2) is encoded by the encoder 16 and notified to the management module 18, while the third set of frames (denoted by 3) is temporally buffered in the buffer 14. Here, the number of frames arrive in the buffer 14 can be obtained as new_arrival₂=(current_time₂−last arrival_time₂)/frame interval. As such, the management module 18 can repeat these steps to continue monitoring the fullness level of the buffer 14. In an alternate embodiment, as the received data stream is stored in the input of the buffer 14, the buffer may send a fullness level signal over a time interval to the management module 18 directly.

Once the fullness level of the buffer is obtained as described above, the management module 18 can determine whether to increase or decrease the complexity of the encoder 16 according to the look up table stored in the memory 20. Thus, the buffer fullness is used as a parameter to determine when and how much to change the complexity in accordance with the present invention. In one approach, the management module 18 switches the encoder to a higher complexity to take advantage of the buffer 14 and reduce the bit rate when the buffer fullness is lower than a pre-set threshold, and switches the encoder to a lower complexity when buffer fullness is higher than the pre-set threshold. Note that the drawback of this approach is that frequent switches can result and causes both system overhead and fluctuation in bit rate. To address this problem, the number of switching can be reduced by setting a range of threshold so that only those buffer levels that deviate from a prescribed range of the threshold need to switch. For example, if the desired buffer fullness level is 75%, then the range from 65% to 85% can be prescribed as an acceptable range. When buffer fullness level stays within the acceptable range, no action is performed by the management module 18. Switching occurs only when buffer fullness level goes above 85% or below 65%.

Now, the provision of estimating the computation load to support a dynamic encoding process according to the present invention will be explained in a detailed description. The following flow chart of FIG. 3 shows the operation of a software embodiment of the management module 18. This flow chart is generally applicable to a hardware embodiment as well.

FIG. 4 illustrates the logic diagram of a method for encoding a stream of data blocks. The process begins at step 100 where the encoder 16 is initially preset to encode the incoming stream of data blocks at a particular mode. Here, the stream of data blocks may include a stream of video frames that have been provided from a video capture device. Then, in step 110, the encoding process begins by storing a first grouping of data blocks of a first sequence in the buffer 14. Having stored the first grouping in the buffer 14, one of the data blocks is retrieved and then encoded based on a relational data encoding convention. After encoding a frame, it is determined whether it is the last frame in step 115. If yes, the operation stops; otherwise, it proceeds to step 120.

In step 120, the fullness level of the buffer 14 is monitored by the management module 18 during the encoding process as described with respect to FIG. 3. Thereafter, it is determined whether the fullness of the buffer level is within a predetermined upper and lower threshold range in step 130. If so, no switching of complexity is performed and returns to step 110. However, if the fullness buffer level exceeds the upper threshold limit in step 140, the complexity of the encoder 16 is lowered by a specified amount in step 150. However, if the fullness buffer level is lower than the lower threshold limit in step 160, then the complexity of the encoder 16 is increased by a specified amount in step 180. It is noted that the amount of scaling the CPU loads of the components of the encoder 16 can be varied according to the predetermined look up table set by an operator and the available process capabilities of the encoder 16. As a result, a frame drop or unexpected results associated with exceeding the maximum CPU load of the encoder 16 can be avoided.

While the preferred embodiments of the present invention have been illustrated and described, it will be understood by those skilled in the art that various changes and modifications may be made, and equivalents may be substituted for elements thereof without departing from the true scope of the present invention. Therefore, it is intended that the present invention not be limited to the particular embodiment disclosed as the best mode contemplated for carrying out the present invention, but that the present invention include all embodiments falling within the scope of the appended claims.

What is claimed is:

1. A method for encoding a stream of data blocks using a scalable encoder, the method comprising the steps of:
receiving a stream of data blocks;
storing said received data blocks in a buffer;
encoding a first sequence of said stored data blocks from said buffer to produce a first encoded data block;
monitoring the fullness level of said buffer for comparison with a predetermined threshold range; and,
adjusting the complexity of said encoder based on said comparison outcome.

2. The method of claim 1, wherein the step of adjusting the complexity of said encoder based on said comparison outcome comprises the steps of:
decreasing the complexity of said encoder when the fullness level of said buffer exceeds an upper range of said threshold limit; and,
encoding a second data block at said decreased complexity to produce a second encoded data block.

3. The method of claim 2, wherein the step of decreasing the complexity of said encoder is performed according to a predetermined encoding configuration table.

4. The method of claim 1, wherein the step of adjusting the complexity of said encoder based on said comparison outcome comprises the steps of:
increasing the complexity of said encoder when the fullness level of said buffer is below a lower level of said predetermined threshold range; and,
encoding a second data block at said increased complexity to produce a second encoded data block.

5. The method of claim 4, wherein the step of increasing the complexity of said encoder is performed according to a predetermined encoding configuration table.

6. The method of claim 1, wherein the step of adjusting the complexity of said encoder based on said comparison outcome comprises the step of maintaining the complexity of said encoder when the fullness level of said buffer falls within said predetermined threshold range.

7. The method of claim 1, further comprising the step of storing said first encoded data blocks in a memory medium for subsequent retrieval.

8. The method of claim 1, wherein the stream of data blocks comprise a stream of video frames.

9. A method for encoding a stream of data blocks using a scalable encoder, the method comprises the steps of:
temporarily storing the stream of said data blocks in a buffer;
retrieving a first sequence of said stored data blocks from said buffer;
encoding the first sequence of said stored data blocks from said buffer to produce a first encoded data block;
monitoring the fullness level of said buffer;
comparing the fullness level of said buffer to a predetermined threshold range;
increasing the complexity of said encoder when the fullness level of said buffer is below a lower level of said predetermined threshold range; and,
decreasing the complexity of said encoder when the fullness level of said buffer is below an upper level of said predetermined threshold range.

10. The method of claim 9, further comprising the step of encoding a second data block at said increased complexity to produce a second encoded data block.

11. The method of claim 9, wherein the steps of increasing and decreasing the complexity of said encoder is performed according to a predetermined encoding configuration table.

12. The method of claim 9, further comprising the step of encoding a second data block at said decreased complexity to produce a second encoded data block.

13. The method of claim 9, further comprising the step of maintaining the complexity of said encoder when the fullness level of said buffer falls within said predetermined threshold range.

14. The method of claim 9, further comprising the step of storing said first encoded data blocks in a memory medium for subsequent retrieval.

15. The method of claim 9, wherein the stream of data blocks comprises a stream of video frames.

16. The method of claim 9, wherein the fullness level of said buffer is determined based on an input rate of the stream of said data blocks and processing feedback information from said encoder after producing said first encoded data block.

17. An encoding system for encoding a stream of data blocks, comprising:
an analog-to-digital converter for converting analog signals from a plurality of sources into digital signals;
a buffer for receiving said converted digital signals at a predefined rate;
a memory for storing a predetermined encoding table;
an encoder for encoding the stream of data blocks stored in said buffer;
a management module, operatively coupled to said buffer, said encoder, and said memory, wherein said management module is operable to: (a) receive the stream of said data blocks; (b) store said received data blocks in said buffer; (c) cause to encode a first sequence of said stored data blocks from said buffer to produce a first encoded data block; (d) monitor the fullness level of said buffer for comparison with a predetermined threshold range; (e) cause to adjust the complexity of said encoder based on said comparison outcome and said predetermined encoding table; and, (f) cause to encode a second data block at said adjusted complexity to produce a second encoded data block.

18. The system of claim 17, wherein said management module is further operable to decrease the complexity of said encoder when the fullness level of said buffer exceeds an upper range of said threshold limit.

19. The system of claim 17, wherein said management module is further operable to increase the complexity of said encoder when the fullness level of said buffer is below a lower level of said predetermined threshold range.

20. The system of claim 17, wherein said management module is further operable to maintain the complexity of said encoder when the fullness level of said buffer falls within said predetermined threshold range.

21. The system of claim 17, wherein the stream of data blocks comprise a stream of video frames.
